(19) United States
(12) Patent Application Publication
(10) Pub. No.: US 2010/0113626 A1
(43) Pub. Date: May 6, 2010

(54) OPAQUE CONTAINERS CONTAINING COLORED RECYCLED POLYESTER

(75) Inventor: Zhenguo LIU, (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA North America S.ar.l., Wilmington, DE (US)

(21) Appl. No.: 12/375,704

(22) PCT Filed: Aug. 21, 2007
(86) PCT No.: PCT/US2007/076383

§ 371 Date: Oct. 6, 2009

Related U.S. Application Data
(60) Provisional application No. 60/840,626, filed on Aug. 28, 2006.

(51) Int. Cl. C08J 11/06; C08L 67/00; C08K 3/22; C08K 3/34; C08K 3/26; C08K 3/30; C08K 3/08

(52) U.S. Cl. 521/48; 524/601; 524/432; 524/450; 524/425; 524/424; 524/418; 524/423; 524/445; 524/449; 524/430; 524/441; 524/539

(57) ABSTRACT

The present invention relates to a composition comprising a colored recycled polyethylene terephthalate (RPET) and an opacifying material. The composition can further comprise a virgin polyethylene terephthalate (PET), a high gas barrier or an oxygen scavenging compound. Suitable opacifying material, suitable high gas barrier polymer and suitable oxygen scavenging compound are disclosed herein. Other embodiments of the present invention include articles produced from these compositions and processes for producing these compositions.

This application claims the benefit of U.S. Provisional Application No. 60/840,626, filed Aug. 28, 2006.

### FIELD OF THE INVENTION

This invention relates to opaque polyester resins containing colored recycled polyester, a method for making these resins, and articles made from such resins. In addition the invention relates to such opaque polyester resins that have superior gas barrier properties than clear polyester resins.

### BACKGROUND OF THE INVENTION

Polyesters, and in particular polyethylene terephthalate (PET) and its copolymers, are widely used in the manufacture of packaging items. One large application is in the manufacture of food packaging items such as films, beverage bottles and the like. Beverage bottles used for packing carbonated soft drinks, juice and water are typically colorless. However there is a growing trend to color these bottles to differentiate products. In addition polyester beer bottles are being commercialized, which need to be colored, normally amber or green, to protect the contents from the deleterious effects of ultra-violet light. Other polyester packaging articles also need a colorant for protection, for instance packages for pharmaceuticals, cosmetics, detergents, agrochemicals and the like.

A major issue has been recognized that, with the increase of use of polyester packaging materials, there is a need to recycle these materials. Currently polyester bottles are recycled through a mechanical recycling process. Bottles are collected and are preferentially color sorted into clear, green, blue and other color/opaque streams before further treatment. These separate bottle streams are ground into flakes of typical thickness 0.15 to 0.4 mm with lateral dimensions in the range 0.4 cm to 2 cm, separation of recycled PET (RPET) from contaminants by caustic washing at 80 to 85° C. (flotation or other means), then dried and sold as flakes or vacuum extruded into pellets. Solid-state polymerization of the pellets at temperatures of 200 to 220° C., under a nitrogen gas flow or vacuum, for 1 to 6 hours to regain the IV loss during this recycle process to make the original bottles if necessary. This recycle process preferably yields pellets of clear, green, blue and a mixture of other colored and opaque pellets from the sorted streams. There are many variations of this process, including automated separation of the colored flakes at the end of the process.

The clear recycled polyester flakes/pellets have the most value and are mixed with virgin polyester pellets to manufacture new containers. The recycle colored streams are used to produce strapping materials, and in the polyester fiber business to provide materials such as fiberfill and other insulating materials for applications in which the color of the fiber is unimportant since it is covered by other materials, for example stuffing fiber for upholstery.

These markets that can use the colored recycle polyester products are now fully utilizing the maximum amount that they need. This has resulted in an increasing excess amount of colored recycle polyester that has to be disposed. The producers of polyester packaging materials are therefore reluctant to further increase the quantity of colored packaging materials. Thus slowing the introduction of other colored polyester articles, for example beer bottles.

Therefore a need exists to find uses of these colored recycle streams.

WO 03/051958 discloses a process for making food grade polyester resin containing transparent waste. This application discloses that a low level of colored waste could be used, using an additional amount of a cobalt salt to offset the increased yellowness and meet the industry standard for “clear” bottles. It did not teach that higher levels of colored waste, or even opaque waste could be used as the base resin for opaque bottles.

The problem of recycling moderate to high concentrations of colored (and opaque) RPET into material that can be reused in a bottle making process without adverse color effects has not been solved.

### SUMMARY OF THE INVENTION

In accordance with the present invention, it has been found that moderate to high concentrations of colored and/or opaque recycled polyethylene terephthalate (RPET) can be recycled into material for reuse in a bottle making process without adverse color effects. The present invention includes a composition comprising a colored recycled polyethylene terephthalate (RPET), and an opacifying material. The composition can further comprise a virgin polyethylene terephthalate (PET), a high gas barrier polymer and an oxygen scavenging polymer.

The present invention also relates to articles produced from such compositions and processes for producing these compositions.

### DETAILED DESCRIPTION OF THE INVENTION

Generally, this invention can be characterized by an opaque polyester resin containing colored (and optionally opaque) recycled polyester. The present invention includes a composition comprising a colored recycled polyethylene terephthalate (RPET) and an opacifying material. The composition can further comprise a virgin polyethylene terephthalate (PET), a high gas barrier polymer and an oxygen scavenging polymer.

In the present invention any opacifying material compatible with the polyester resin can be used; these include i) metal powders such as aluminum, copper, iron, zinc and tin; ii) metal oxides of aluminum, titanium, zinc, tin, zirconium and silicon; iii) silica, iv) fumed silica, v) fumed alumina, vi) metal silicates of aluminum and calcium; vii) carbonates of calcium, barium, zinc and magnesium; viii) sulfides of calcium, barium, zinc and magnesium; ix) sulfates of calcium, barium, zinc and magnesium; x) clays, xi) nanoclays, xii) mica, xiii) opaque recycled polyethylene terephthalate, and xiv) mixtures thereof. The polyester resin can contain from about 0.1 to about 5 weight % of opacifying material. Opacifying materials can be those that give a distinct metal appearance such as aluminum powder, and mica which gives pearlescence.

In the present invention the colored recycled polyethylene terephthalate (RPET) can be present in an amount of at least about 10 weight %, for example in the range of about 10 weight % to about 99.9 weight %; or in an amount of at least about 20 weight %, for example in the range of about 20 weight % to about 99.9 weight %; or in an amount of at least about 22 weight %, for example in the range of about 22 weight % to about 99.9 weight %.

In the present invention, no restriction is placed on other polymer additives. Therefore, the present invention can consider all types of compatible pigments, dyes, fillers, branching agents, reheat agents, anti-blocking agents, antioxidants, anti-static agents, biocides, blowing agents, coupling agents, flame retardants, fillers, heat stabilizers, impact modifiers, light stabilizers, lubricants, plasticizers, processing aids, and slip agents.

Suitable high gas barrier polymers for the present invention can be: polyesters such as polyethylene isophthalate, polyethylene naphthalate, polytrimethylene naphthalate, polyethylene bibenzoate and polyglycolic acid; polyamides, such as MXD6 sold by Mitsubishi Gas Chemical Co., Inc. and Aegis sold by Honeywell; or ethylene vinyl alcohol copolymers sold by Kuraray. These can be added, either singly or as mixtures to the resin in the range of from about 1 to about 10% by weight (based on the weight of said resin).

Suitable oxygen scavenging compounds for the present invention can be: polyamides, such as MXD6 sold by Mitsubishi Gas Chemical Co. and Aegis sold by Honeywell, Inc. Type 6007; copolyesters containing polyolefin segments such as polybutadiene sold by BP Chemical as Amosorb DFC; ethylenically unsaturated hydrocarbons such as ethylene methyl acrylate cyclohexene sold by Chevron Phillips Chemical. Company as EMCM resin Type OSP; or other oxidizable polymers. The addition of a transition metal catalyst, for example a cobalt salt, is used in these active oxygen scavenging systems. Oxygen scavengers can be added to the resin, either singly or as a mixture in a range of from about 1 to about 10% by weight (based on the weight of said resin).

In another embodiment, the present invention relates to processes for producing compositions comprising a colored RPET, a virgin PET and an opacifying material; and optionally opaque RPET; and/or a high gas barrier or oxygen scavenging polymer. In addition the method to produce articles from these compositions are within the scope of this invention. In principle, these processes allow for a closed loop for recycling bottles back into new bottles without any concern for color or property variations as long as the RPET is cleaned of any contamination which arises in its use as a packing material in its original market or by its use by the consumer as a container for liquid or solid chemicals.

The colored and, if required the opaque, RPET resin can be made into a blend with PET by a variety of methods, for example:
1. The unsorted clean, colored (and optionally opaque) flakes can be pelletized, solid-state polymerized if necessary, and used directly for injection molding of the preform. A master batch of the opacifying material is added to the injection molding machine at a level to give the required degree of opacity. Alternatively opaque flakes and/or a master batch of the opacifying material can be added to the pelletizer or extruder at a rate controlled to give the final resin a uniform specified degree of opacity.
2. If the pellets obtained by process 1 are too highly colored, then they can be blended with virgin PET or clear RPET, either as a pellet blend or at pelletization or extrusion.
3. The unsorted clean, colored (and optionally opaque) flakes can be directly fed to a glycolysis process and repolymerized to produce colored pellets, which can be further polymerized. The opacifying material can be added during polyesterification or polycondensation, to a vessel operating at a super atmospheric pressure, at atmospheric pressure or under a vacuum, depending on the type of addition equipment used, or in a transfer line between any two of the vessels in the melt process, or into the first vessel of the process or as a polymer based or substrate based master batch during injection molding.
4. Process 3 can be used without the addition of the opacifying material during polymerization, with the resultant pellets blended with virgin chip. The opacifying material being added as a master hatch during injection molding.

If gas barrier polymers and/or oxygen scavenging compounds are used they can be normally added as pellet blends with the colored or colored opacified, RPET at injection molding.

The final resin blend of the present invention can be heated and extruded into uniform, single layer preforms. The preforms can then be heated to about 100-120° C. and blown-molded into a uniform, single layer containers at a stretch ratio of about 8 to 14. The stretch ratio is the stretch in the radial direction times the stretch in the length (axial) direction. Thus if a preform is blown into a container, it can be stretched about three times its length and stretched about four times its diameter giving a stretch ratio of twelve (3×4).

Articles produced from such compositions, such as films, sheets, fibers and blow molded containers, and in particular stretch-blow molded bottles are within the scope of this invention.

Generally polyesters can be prepared by one of two processes, namely: (1) the ester process and (2) the acid process. The ester process is where a dicarboxylic ester (such as dimethyl terephthalate) is reacted with ethylene glycol or other diol in an ester interchange reaction. Because the reaction is reversible, it is generally necessary to remove the alcohol (methanol when dimethyl terephthalate is employed) to completely convert the raw materials into monomers. Certain catalysts are well known for use in the ester interchange reaction. In the past, catalytic activity was then sequestered by introducing a phosphorus compound, for example polyphosphoric acid, at the end of the ester interchange reaction.

Then the monomer undergoes polycondensation and the catalyst employed in this reaction is generally an antimony or titanium compound or other well known polycondensation catalyst.

In the second method for making polyester, an acid (such as terephthalic acid) is reacted with a diol (such as ethylene glycol) by a direct esterification reaction producing monomer and water. This reaction is also reversible like the ester process and thus to drive the reaction to completion one must remove the water. The direct esterification step does not require a catalyst. The monomer then undergoes polycondensation to form polyester just as in the ester process, and the catalyst and conditions employed are generally the same as those for the ester process.

For most container applications this melt phase polyester is further polymerized to a higher molecular weight by a solid state polymerization. High molecular weight resins, and the MTP (melt to preform process), produced directly in the melt phase currently have limited application in packaging markets. The scope of the current invention also covers this future possibility

In summary, in the ester process there are two steps, namely: (1) an ester interchange, and (2) polycondensation. In the acid process there are also two steps, namely: (1) direct esterification, and (2) polycondensation.

Suitable polyesters can be produced from the reaction of a diacid or diester component comprising at least 65 mole % of an aromatic dicarboxylic acid or C₁-C₄ dialkyl ester of an aromatic dicarboxylic acid, for example at least 70 mole % to at least 94 mole % or at least 94 mole %, and a diol component comprising at least 65% mole % ethylene glycol, for example at least 70 mole % to at least 95 mole % or at least 95 mole %. The aromatic diacid component can be terephthalic acid and the diol component can be ethylene glycol, thereby forming polyethylene terephthalate (PET). The mole percent for the entire diacid components total 100 mole %, and the mole percentage for the entire diol components total 100 mole %.

Where the polyester components are modified by one or more diol components other than ethylene glycol, suitable diol components of the described polyester can be selected from 1,4-cyclohexanedimethanol, 1,2-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, or diols containing one or more oxygen atoms in the chain, for example diethylene glycol, triethylene glycol, dipropylene glycol, tripropylene glycol or mixtures of these, and the like. In general, these diols contain 2 to 18, for example 2 to 8 carbon atoms. Cycloaliphatic diols can be employed in their cis or trans configuration or as mixture of both forms. Modifying diol components can be 1,4-cyclohexanedimethanol or diethylene glycol, or a mixture of these.

Where the polyester components are modified by one or more acid components other than terephthalic acid, the suitable acid components (aliphatic, alicyclic, or aromatic dicarboxylic acids) of the linear polyester can be selected from isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, bibenzoic acid, or mixtures of these and the like. In the polymer preparation, a functional acid derivative thereof can be used such as the dimethyl, diethyl, or dipropyl ester of the dicarboxylic acid. The anhydrides or acid halides of these acids also can be employed where practical. These acid modifiers generally retard the crystallization rate compared to terephthalic acid. Suited in the present invention is the copolymer of polyethylene terephthalate (PET) and isophthalic acid. Generally, the isophthalic acid is present from about 1 mole % to about 10 mole % or about 1.5 mole % to about 6 mole % of the copolymer.

In addition to polyester made from terephthalic acid (or dimethyl terephthalate) and ethylene glycol, or a modified polyester as stated above, the present invention also includes the use of 100% of an aromatic diacid such as 2,6-naphthalene dicarboxylic acid or bibenzoic acid, or their diesters, and a modified polyester made by reacting at least 85 mole % of the dicarboxylate from these aromatic diacids/diesters with any of the above comonomers.

Upon completion of the production of the polyester resin by melt polycondensation, it is often desirable to subject the resin to a solid state polymerization process to increase the molecular weight (Intrinsic Viscosity (IV)) for use in the production of bottles. This process usually consists of a crystallization step in which the resin is heated to about 180° C., in one or more stages, followed by heating at 200 to 220° C. with a stream of heated nitrogen to remove the by-products of the solid-state polymerization as well as by-products of the melt polymerization such as acetaldehyde in the case of PET. Other methods of increasing the molecular weight are also within the scope of the present invention, such as by maintaining the resin in the melt polycondensation stage until the required intrinsic viscosity increase has been achieved by employing certain reactors. In this case the subsequent steps after the last melt reactor may comprise one or all of the following steps, a possible addition of at least one additive, formation of solid particles, crystallization of these particles and drying to remove moisture if present. All these processes are known to those skilled in the art.

The exact formulation of the virgin polyester will be determined by the properties of the colored and opaque RPET and their blend level, in order for the blend to meet the product and process specifications for the formation of the article such as an injection stretch blow molded bottle.

### Testing Procedures

Intrinsic viscosity (IV) is determined by dissolving 0.2 grams of an amorphous polymer composition in 20 milliliters of dichloroacetic acid at a temperature of 25° C. and using an Ubbelhode viscometer to determine the relative viscosity (RV). RV is converted to IV using the equation:

IV=[(RV−1×0.691))+0.063.

Haze was determined with a Hunter Haze meter. Color was measured with a Hunter Color Quest II Instrument using D65 illuminant, 2° observer, and reported as 1976 CEI values of color and brightness, L, a* and b*. Opacity was measured by the % transmission of visible light (500 nm) through a 0.3 mm sheet of the material. A material exhibiting a transmission of less than 15% was considered opaque. This, in bottle sidewalls, corresponds to a haze of greater than 85%.

### Examples

### Example 1

Aluminum powder (Siberline, 8 micron average diameter) in a polyethylene carrier was blended with a commercial PET bottle resin (Invista type 1101) to give a sample with a loading of 0.4 weight % Al. This resin was injection molded into preforms and stretch blow molded into 2 liter bottles. Sections of the bottle sidewall were cut into small flakes. A control sample using similar sidewalls from bottles prepared from type 1101 was also cut into small flakes.

About 100 g of each sample of flakes was reacted with ethylene glycol (EG) at a weight ratio of about 10:7 flake:EG. This mixture was heated at 192° C. under reflux for approximately 275 minutes to give the monomer of PET, bis-hydroxyethylterephthalate (BHET).

The 2 samples of monomer from this glycolysis reaction, one containing the Al powder and one containing only standard type 1101, were re-polymerized with an equal weight of pure BHET, using antimony trioxide as a catalyst (an additional 100 ppm to give 280 ppm Sb in the final resin) to an IV of 0.61.

The polycondensation times for the 2 samples were similar. The 2 sample resins also had similar levels of diethylene glycol (DEG), and the resin from the glycolyzed BHET containing the Al powder had a higher carboxyl end group (CEG).

These results demonstrate that RPET containing an opacifying material can be glycolyzed back to monomer and repolymerized to a PET polymer with similar results as compared to standard bottle resin (type 1101).

### Example 2

Colored RPET was obtained from commercial sources and blended at 20 weight % with type 1101 clear bottle resin and the 1101 resin containing 0.4 weight % Al prepared as in Example 1. These blends were injection molded into preforms and stretch blow molded into 2 liter bottles. The color and haze values of these bottles are set forth in Table 1.

TABLE 1

| RPET color | Al, wt % | L | a* | b* | Haze, % |
|---|---|---|---|---|---|
| Green | 0 | 92.5 | −3.5 | 5.5 | 18.5 |
| Green | 0.4 | 4.5 | −1 | −0.2 | 88 |
| Amber | 0 | 84.5 | 6 | 20 | 11.5 |
| Amber | 0.4 | 5 | 1 | 2.5 | 87.5 |

These results demonstrate that Al powder in a PET resin has sufficient opacity (high haze) to mask the effects of colored recycle flake in the resin.

Thus it is apparent that there has been provided, in accordance with the invention, a composition and a process that fully satisfied the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the appended claims.

What is claimed is:

1. A composition comprising a colored recycled polyethylene terephthalate and an opacifying material.

2. The composition of claim 1, wherein said opacifying material comprises at least one member selected from the group consisting of i) metal powder, ii) metal oxides of aluminum, titanium, zinc, tin, zirconium and silicon; iii) silica, iv) fumed silica, v) fumed alumina, vi) metal silicates of aluminum and calcium; vii) carbonates of calcium, barium, zinc and magnesium; viii) sulfides of calcium, barium, zinc and magnesium; ix) sulfates of calcium, barium, zinc and magnesium; x) clays, xi) nanoclays, xii) mica, xiii) opaque recycled polyethylene terephthalate, and xiv) mixtures thereof.

3. The composition of claim 2, wherein said metal powder comprises at least one member selected from the group consisting of aluminum, copper, iron, zinc, tin and mixtures thereof.

4. The composition of claim 3, wherein said metal powder is aluminum.

5. The composition of claim 1, wherein said opacifying material is present in a concentration from about 0.1 weight % to about 5 weight %.

6. The composition of claim 1, wherein said colored recycled polyethylene terephthalate is present in a concentration of at least about 10 weight %.

7. The composition of claim 1, further comprising virgin polyethylene terephthalate.

8. The composition of claim 1, further comprising a high gas barrier polymer.

9. The composition of claim 1, further comprising an oxygen scavenging polymer.

10. An article comprising a colored recycled polyethylene terephthalate and an opacifying material.

11. The article of claim 10, further comprising virgin polyethylene terephthalate.

12. An article made from a polyester resin comprising a recycled polyethylene terephthalate and an opacifying material.

13. The article of claim 12, further comprising virgin polyethylene terephthalate.

14. A process for making a polyester resin performs comprising: pelletizing unsorted clean, colored and opaque flakes, introducing said pelletized flakes into an injection-molding machine to melt said flakes and injection-molding said molten flakes into a preform.

15. The process of claim 14, wherein after said pelletizing, said pellets are solid-state polymerized to increase the viscosity.

16. The process of claim 14 or 15, wherein said step of introducing pelletized flakes also includes introducing additional opacifying material into the injection molding machine.

17. A process for making colored, opacified recycled polyethylene terephthalate pellets comprising: pelletizing unsorted, colored and opaque recycled polyethylene terephthalate flakes and optionally solid-state polymerization.

18. The process of claim 17, wherein additional opacifying material and optionally clear flakes, are added during said pelletizing to provide pellets of the correct color specification.

19. A process for making colored, opacified recycled polyethylene terephthalate pellets comprising: adding unsorted, colored and opaque recycled polyethylene terephthalate flakes in a glycolysis process, or to the monomer after esterification, to form a colored monomer; and polycondensating said monomer to a polyester resin.
